(19) United States
(12) Patent Application Publication
(10) Pub. No.: US 2023/0245075 A1
(43) Pub. Date: Aug. 3, 2023

(54) PRECOMPUTING USER TIME RESOURCE UTILIZATION FOR QUERYING FOR APPOINTMENT DISTRIBUTION

(71) Applicant: salesforce.com, inc., San Francisco, CA (US)

(72) Inventors: Santosh Munugota, Hyderabad (IN); Ankit Srivastava, Hyderabad (IN); Ashwin Simha Reddy Vengareddy, Hyderabad (IN); Chakravarthi Muppalla, Hyderabad (IN)

(21) Appl. No.: 17/649,893

(22) Filed: Feb. 3, 2022

(51) Int. Cl. G06Q 10/10; G06Q 10/06

(52) U.S. Cl. CPC G06Q 10/1097; G06Q 10/06312

(57) ABSTRACT

Methods, systems, apparatuses, and computer program products are described. A scheduling platform may retrieve information indicating unavailable time resources for a set of users, a time resource representing a time period during which a user may be assigned an appointment. The scheduling platform may use the information to compute utilization scores for each user, which indicate an aggregation of unavailable time resources for a user. After receiving a request to utilize an available time resource for a specified time slot, the scheduling platform may query a data object storing the utilization scores to identify a subset of users having lowest utilization scores with respect the set of users. The scheduling platform may retrieve information indicating whether the subset of users are available during the specified time slot and identify one or more users available for the specified time slot.

### FIELD OF TECHNOLOGY

The present disclosure relates generally to database systems and data processing, and more specifically to precomputing user time resource utilization for querying for appointment distribution.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform (or another platform) may support systems that are used to schedule customer appointments with particular resources (e.g., people, meeting times, locations). For example, a user of an organization (e.g., a customer, an employee) may use a scheduling service to assign appointments to a particular resource explicitly or based on logic that may calculate how available different resources are across various calendars within the organization. However, calculating resource availability across multiple calendars and assigning appointments to particular resources from a large set of resources may be computationally intensive and introduce performance issues and workflow inefficiencies to the cloud platform.

### BRIEF DESCRIPTION OF THE DRAWINGS

FIG. 1 illustrates an example of a data processing system that supports precomputing user time resource utilization for querying for appointment distribution in accordance with aspects of the present disclosure.

FIG. 2 illustrates an example of a computing architecture that supports precomputing user time resource utilization for querying for appointment distribution in accordance with aspects of the present disclosure.

FIG. 3 illustrates an example of an appointment distribution flow that supports precomputing user time resource utilization for querying for appointment distribution in accordance with aspects of the present disclosure.

FIG. 4 illustrates an example of a utilization score calculation that supports precomputing user time resource utilization for querying for appointment distribution in accordance with aspects of the present disclosure.

FIGS. 5 through 7 illustrate examples of process flows that support precomputing user time resource utilization for querying for appointment distribution in accordance with aspects of the present disclosure.

FIG. 8 shows a block diagram of an apparatus that supports precomputing user time resource utilization for querying for appointment distribution in accordance with aspects of the present disclosure.

FIG. 9 shows a block diagram of a scheduling platform that supports precomputing user time resource utilization for querying for appointment distribution in accordance with aspects of the present disclosure.

FIG. 10 shows a diagram of a system including a device that supports precomputing user time resource utilization for querying for appointment distribution in accordance with aspects of the present disclosure.

FIGS. 11 through 13 show flowcharts illustrating methods that support precomputing user time resource utilization for querying for appointment distribution in accordance with aspects of the present disclosure.

### DETAILED DESCRIPTION

An organization may use a scheduling platform to assign or schedule appointments to users of the organization. In some examples, users (e.g., employees of the organization, customer service agents) may schedule appointments for themselves or on behalf of a colleague. In some other examples, appointments may be requested by customers of the organization. In some cases, users may be referred to as resources (e.g., personnel who may be assigned an appointment with a customer). In addition, each user may have time resources, which may correspond to time periods during which the user may be assigned an appointment. Time resource availability information for a user, which may indicate when the user is available or unavailable, may be stored and managed in a calendar application corresponding to the user and accessed by the scheduling platform to schedule appointments. The scheduling platform may aggregate information about the unavailability of time resources corresponding to a set of users supported by the scheduling platform and assign appointments to the users accordingly.

In some cases, the scheduling platform may explicitly assign an appointment to a user of the set of users supported by the scheduling platform. For example, a customer may request and be assigned an appointment with a particular user (e.g., resource) at a particular time (e.g., time resource). In some other examples, the scheduling platform may assign appointments implicitly, based on a preset logic such as a load balancing logic, a Round Robin logic, a net-promoter score (NPS)-based logic, or any other preset logic. For example, the scheduling platform may apply a preset logic (e.g., an algorithm) to the aggregated time resource availability information for the set of users, and the preset logic may determine users to be assigned appointments based on the relative busyness of users or other factors. However, retrieving the time resource availability information from the set of users across various calendar applications and assigning an appointment to a specific user and time resource based on the preset logic may be computationally intensive and result in decreased performance and decreased user satisfaction as the appointments may be distributed unevenly and inefficiently.

Techniques described herein provide for precomputing user time resource utilization information, which may be queried for appointment distribution. For example, a scheduling platform may assign appointments to users of an organization (e.g., employees) based on an availability of time resources corresponding to the users (e.g., time periods during which the users may be assigned an appointment). In some examples, the scheduling platform may retrieve time resource utilization information for a set of users supported by the scheduling platform from a set of time resource management application instances (e.g., calendar applications) corresponding to the set of users. The time resource utilization information may indicate unavailable time resources for the set of users during a configured time period. For example, the time resource utilization information may indicate how busy each resource is (e.g., in terms of a number of meetings or a number of hours) during a particular time period (e.g., a day, a week, a month). Using the time resource utilization information, the scheduling platform may compute utilization scores for each user of the set of users. A utilization score may include an aggregation of the unavailable time resources for a user for the configured time period.

After receiving a request from a customer to schedule an appointment during a specific time slot, the scheduling platform may query a data object storing the utilization scores for the set of users. The scheduling platform may query the data object to identify a subset of users having a lowest utilizations score compared to the set of users (e.g., the users in the subset of users will have the lowest utilization scores from the set of users). That is, in order to schedule the appointment during a specific time slot, the scheduling platform may first reduce the set of users to a subset of users that are the least busy, which may reduce computational complexity and increase efficiency.

In some cases, the scheduling platform may retrieve time slot availability information corresponding to the configured time period for the subset of users from a subset of corresponding time resource management application instances (e.g., instead of from the time resource management application instances for the full set of users). The time slot availability information may indicate what specific time slots are unavailable for each user of the subset of users during the configured time period. Using the time slot availability information, the scheduling platform may identify one or more users from the subset of users having an available time resource for the specified time slot, and the scheduling platform may assign the requested appointment to at least one of the identified users using a load balancing logic and the utilization scores. That is, the scheduling platform may assign the appointment to a user with the lowest utilization score of the subset of users that is available during the specified time slot. Reducing the set of users to the subset of users based on utilization scores, and assigning the appointment to a user of the subset of users instead of from the set of users may increase performance and reduce computational resource expenditure, reduce latency, among other technical benefits.

Aspects of the disclosure are initially described in the context of an environment supporting an on-demand database service. Aspects of the disclosure are then described in the context of computing architectures, appointment distribution flows, utilization score calculations, and process flows. Aspects of the disclosure are further illustrated by and described with reference to apparatus diagrams, system diagrams, and flowcharts that relate to precomputing user time resource utilization for querying for appointment distribution.

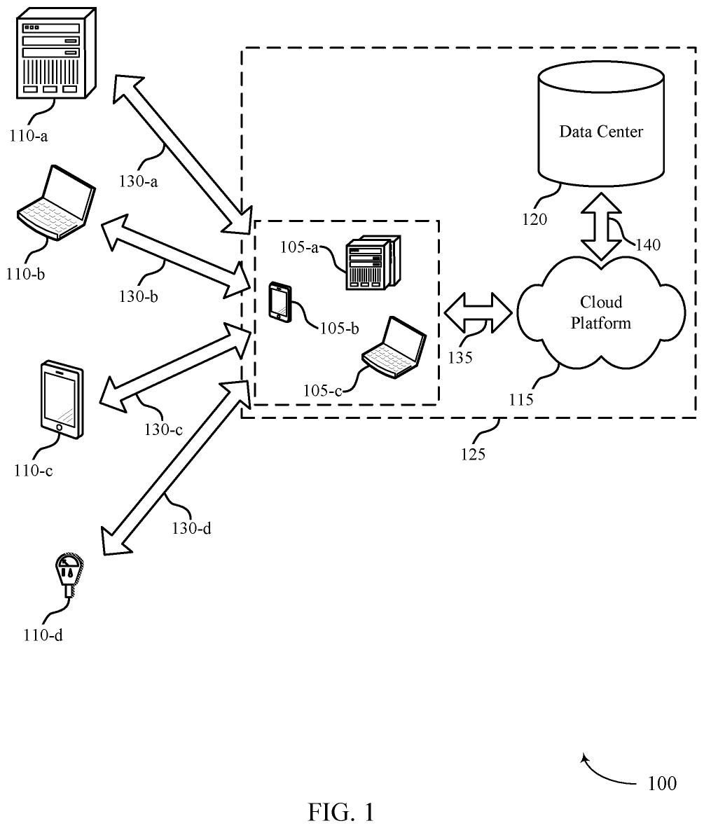

FIG. 1 illustrates an example of a data processing system 100 for cloud computing that supports precomputing user time resource utilization for querying for appointment distribution in accordance with various aspects of the present disclosure. The data processing system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud platform 115 and/or the subsystem 125 may support a scheduling platform used to assign or schedule appointments to users (e.g., contacts 110) of the organization. In some examples, users (e.g., employees of the organization, customer service agents) may schedule appointments for themselves or on behalf of a colleague. In some other examples, appointments may be requested by customers of the organization. In some cases, users may be referred to as resources (e.g., personnel who may be assigned an appointment with a customer). In addition, each user may have time resources, which may correspond to time periods during which the user may be assigned an appointment. Time resource availability information for a user, which may indicate when the user is available or unavailable, may be stored and managed in a calendar application running on a machine associated with the user. An instance of a calendar application running on a machine may be referred to as a time resource management application instance. These individual calendar application instances may be accessed by the scheduling platform (e.g., via API calls or the like) to schedule appointments on the fly or otherwise at the time of a scheduling request. The scheduling platform may retrieve real-time unavailability information from each calendar application instance for a set of users and aggregate the information about the unavailability of time resources corresponding to the set of users supported by the scheduling platform and assign appointments to the users accordingly.

Some systems may explicitly assign an appointment to a user of the set of users. For example, a customer may request and be assigned an appointment with a particular user (e.g., resource) from the set of users at a particular time (e.g., time resource). In some other examples, a system may assign appointments implicitly, based on a preset logic such as a load balancing logic, a Round Robin logic, an NPS-based logic, or any other preset logic. For example, the scheduling platform may apply a preset logic (e.g., an algorithm) to the aggregated time resource availability information for the set of users, and the preset logic may determine users to be assigned appointments based on the relative busyness of users or other factors. However, the set of users may be relatively large (e.g., more than 1000 users may handle a case at a call center, a medical center, and the like), and retrieving the time resource availability information from the set of users across various calendar applications may be computationally intensive and inefficient and may result in latency. For example, a user of the organization may manually assign an appointment to one call center agent out of thousands of call center agents at a particular time slot, based on the call center agent being available at the particular time slot. By doing so, the user may have queried a calendar application for each individual call center agent who may have been available during the particular time slot, which may be resource intensive and result in decreased performance and decreased user satisfaction as the appointments may be distributed unevenly and inefficiently.

The data processing system 100 may support precomputing user time resource utilization information, which may be queried for appointment distribution. For example, a scheduling platform may assign appointments to users of an organization (e.g., employees) based on an availability of time resources corresponding to the users (e.g., time periods during which the users may be assigned an appointment). In some examples, the scheduling platform may retrieve time resource utilization information for a set of users supported by the scheduling platform from a set of time resource management application instances (e.g., calendar applications) corresponding to the set of users. For example, the scheduling platform may perform this retrieval step on a periodic schedule, or in the background, or during typically less busy times of the day (e.g., early morning), so that the computational resources or latency are not impacting the user at the time a request for an appointment is received by the system. The time resource utilization information may indicate unavailable time resources for the set of users during a configured time period. For example, the time resource utilization information may indicate how busy each resource is (e.g., in terms of a number of meetings or a number of hours) during a particular time period (e.g., a day, a week, a month). Using the time resource utilization information, the scheduling platform may compute utilization scores for each user of the set of users. A utilization score may include an aggregation of the unavailable time resources for a user for the configured time period. In this way, the system may precompute the unavailability of users for a set of users and store this information in a way that is computationally efficient to query at runtime (e.g., when a request for an appointment is received by the system).

After receiving a request from a customer to schedule an appointment during a specific time slot, the scheduling platform may query a data object storing the utilization scores for the set of users. The scheduling platform may query the data object to identify a subset of users having a lowest utilization score compared to the set of users (e.g., the users in the subset of users will have the lowest utilization scores from the set of users). That is, in order to schedule the appointment during a specific time slot, the scheduling platform may first reduce the set of users to a subset of users that are the least busy, which may reduce computational complexity and increase efficiency. For example, rather than having to access the availability information for each time resource management application instance for all of the users, the system may only query the subset of application instances for the subset of users that are identified based on the precomputed utilization scores. That is, the scheduling platform may retrieve time slot availability information corresponding to the configured time period for the subset of users from a subset of corresponding time resource management application instances (e.g., instead of from the full set of users). The time slot availability information may indicate what specific time slots are unavailable for each user of the subset of users during the configured time period.

Using the time slot availability information, the scheduling platform may identify one or more users from the subset of users having an available time resource for the specified time slot, and the scheduling platform may assign the requested appointment to at least one of the identified users using a load balancing logic and the utilization scores. That is, the scheduling platform may assign the appointment to a user with the lowest utilization score of the subset of users that is available during the specified time slot. Reducing the set of users to the subset of users based on utilization scores, and assigning the appointment to a user of the subset of users instead of from the set of users may increase performance, reduce computational intensity, and reduce latency, among other computational benefits.

Distributing appointments using resource utilization scores may support improved performance and reduced processing overhead by reducing a set of users to a subset of users before assigning an appointment. For example, as the techniques described herein support assigning an appointment to a user from a subset of users having a set of lowest utilization scores relative to the set of users, the techniques may support reducing computational intensity and overhead associated with appointment distribution. As another example, as the techniques described herein support applying a predefined or custom logic to the subset of users to identify users having an available time resource for a particular time slot, the techniques may support implementing user-specific logic to most accurately fit the characteristics of the subset of users.

It should be appreciated by a person skilled in the art that one or more aspects of the disclosure may be implemented in a data processing system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

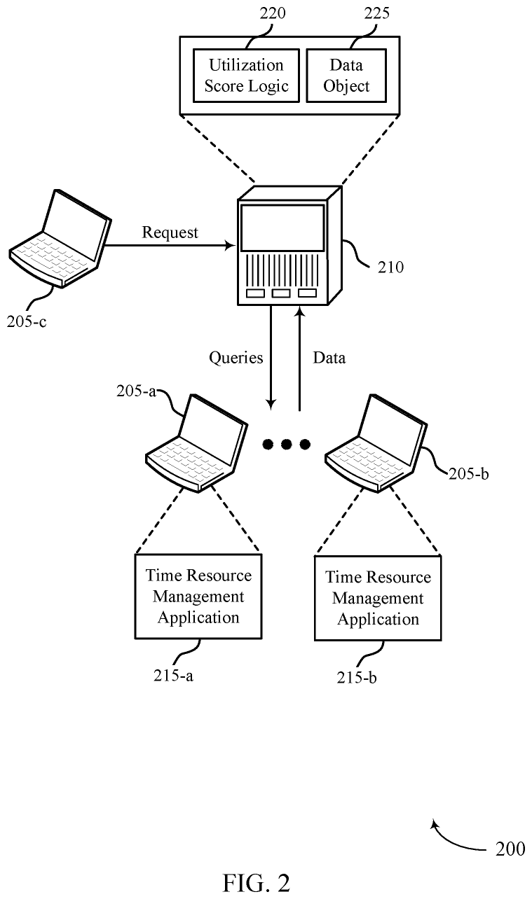

FIG. 2 illustrates an example of a computing architecture 200 that supports precomputing user time resource utilization for querying for appointment distribution in accordance with aspects of the present disclosure. The computing architecture 200 may implement or be implemented by aspects of the data processing system 100. For example, the computing architecture 200 may include a scheduling platform 210, which may be implemented by aspects of a cloud platform 115 or a subsystem 125 as described with reference to FIG. 1. In some examples, multiple users may interact with the scheduling platform 210 using user devices 205, where the scheduling platform 210 may be used as an appointment booking flow.

As described herein, the scheduling platform 210 may support improved appointment distribution using precomputed user time resource utilization scores. For example, the scheduling platform 210 may use utilization scores to schedule customer appointments with a particular user (e.g., resource) at a particular time period (e.g., time resource) and location. The scheduling platform 210 may support a scheduling service used for various business functionalities. For example, users associated with a tenant (e.g., employees of an organization) may use the scheduling platform 210 to manage appointment distribution for the users. In some examples, the scheduling platform 210 may embed scheduling tools directly within a user account to enable users to schedule customer appointments for themselves or on behalf of a colleague (e.g., an outbound request). Additionally or alternatively, the scheduling platform 210 may enable customers or potential customers to schedule appointments with users (e.g., an inbound request). For example, a customer may download an application (e.g., a mobile application) that enables the customer to interact with the scheduling platform 210, or the customer may log into an account for the scheduling platform 210 (e.g., via a website).

In some cases, the scheduling platform 210 may assign appointments to different resources corresponding to different users. The resources may include time resources, which may be time periods during which users (e.g., employees of the organization, customer service agents) may be assigned an appointment. In some examples, a time resource may correspond to a specific time period (e.g., 9:30 am to 10:00 am). In addition, an appointment may be associated with a specific location.

The scheduling platform 210 may retrieve time resource utilization information for a set of users from multiple corresponding time resource management application instances 215. For example, a first user may use a time resource management application instance 215-a via a user device 205-a and a second user may use a time resource management application instance 215-b via a user device 205-b, where the first user and the second user may be employees of the organization. The time resource management application instances 215 may include calendar applications, appointment scheduler applications, personal information management applications, or any other applications that store and manage appointment schedules. The time resource utilization information may indicate unavailable time resources for the first and second users for a configured time period (e.g., a particular day, week, month). For example, the time resource utilization information may indicate that the first user is unavailable for five hours during a particular day (e.g., the first user may already have appointments or events scheduled during the five hours). In another example, the time resource utilization information may indicate that the second user is unavailable for the same one hour each day for a particular week (e.g., the second user may already have an event scheduled between 9:00 am and 10:00 am every day for a week).

Based on retrieving the time resource utilization information from the first user via the user device 205-a and the second user via the user device 205-b (e.g., or any of number of users with corresponding time resource management application instances 215 linked to the scheduling platform 210), the scheduling platform 210 may compute a set of utilization scores for the set of users using a utilization score logic 220. A utilization score may include an aggregation of the unavailable time resources corresponding to the configured time period for each user (e.g., the utilization score may be calculated for a particular time period). For example, a utilization score may indicate how many meetings a user has scheduled in a particular week. For example, the user may have zero meetings scheduled on Monday, Saturday, and Sunday, five meetings on Tuesday, three meetings on Wednesday, four meetings on Thursday, and two meetings on Friday, resulting in a utilization score of 14. In other examples, the utilization score may indicate how many hours a user is busy with scheduled appointments or other calendar events during a given week, how many meetings the user has scheduled during a given month, how many hours the user is busy during a given month, or any other indication of unavailability for a particular time period. The utilization scores may be stored in a data object 225 or any other data structure (e.g., a table) configured for efficient storage and querying.

In some examples, the scheduling platform 210 may calculate the utilization scores based on different criteria, such as a total amount of meeting hours during a consideration period (e.g., the configured time period) or a total number of meetings during the consideration period. A consideration period may be a week, a month, a time slot range, or any other time period supported by a time resource management application instance 215. In addition, the utilization score logic 220 may calculate the utilization scores based on time resource utilization information from different consideration sets, such as service appointments, a calendar specific to the organization managing the scheduling platform 210, an external calendar, or any other type of time resource management application instance 215. For example, a user may define a utilization score as a number of hours a user is busy in a given week according to a service appointment entity.

The scheduling platform 210 may receive a request from a third user (e.g., a customer) via a user device 205-c (e.g., a customer) to utilize an available time resource for a specified time slot (e.g., a particular hour on a particular day). For example, a customer may log into an account for the scheduling platform 210 and indicate a request for an appointment. Based on receiving the request, the scheduling platform 210 may query a data object 225 storing the utilization scores to identify a subset of users (e.g., that are employees of the organization) having a lowest utilization score relative to the set of users. In some cases, the data object 225 may store the utilization scores of all the users with time resource management application instances 215 that are connected to the scheduling platform 210, such as the first user and the second user. As such, the data object 225 may include any combination of low and high utilization scores, where a user with a relatively low utilization score may be relatively less busy than a user with a relatively high utilization score.

In some cases, the scheduling platform 210 may identify the subset of users having a lowest set of corresponding utilization scores before assigning an appointment, instead of assigning an appointment to a user based on the full set of utilization scores stored in the data object 225. Put another way, instead of assigning an appointment to a user having a lowest utilization score (e.g., compared to all other users interacting with the scheduling platform 210), the scheduling platform 210 may first reduce the full set of users to a subset of users including the first user and the second user (e.g., reduce the users from a quantity N to a quantity X, where X<<N). Accordingly, the scheduling platform 210 may assign the appointment to a user of the subset of users.

To assign the appointment, the scheduling platform 210 may retrieve time slot availability information corresponding to the configured time period for the subset of users from a subset of time resource management application instances 215 associated with the subset of users. For example, the first user corresponding to the time resource management application instance 215-a and the second user corresponding to the time resource management application instance 215-b may be included in the subset of users, and as such, the scheduling platform 210 may retrieve time slot availability information for the first and second users. The time slot availability information may indicate whether the time resources for each user of the subset of users are available during the specified time slot. The scheduling platform 210 may identify one or more users from the subset of users that are available during the specified time slot (e.g., that have an available time resource for the specified time slot). For example, the scheduling platform 210 may identify that the first user has an available time resource during the specified time slot, and as such, the scheduling platform 210 may assign the request to the first user.

In some cases, the scheduling platform 210 may assign the request to a user of the subset of users based on a load balancing logic and the utilization scores. The load balancing logic may surface the least utilized users and time resources in the scheduling platform 210 by using the utilization scores to determine a relative business of the time resources corresponding to the subset of users. Distributing the appointments based on a load balancing logic, which distributes the appointments based on the utilization scores of users of the subset of users, may evenly distribute the meeting loads between the users. After assigning the request, the scheduling platform may notify the customer, the user, or both of the assigned appointment.

In some examples, a user may write and implement a custom logic to identify the subset of users. The scheduling platform 210 may receive a user input indicating a user configuration defining a calculation metric for computing the utilization scores. The calculation metric may include a total number of unavailable hours during a time period or a total number of meetings scheduled during the time period. In some other cases, the user configuration may define the subset of users (e.g., determine how may users to include in the subset of users) based on any other logic which may or may not take into account the utilization scores.

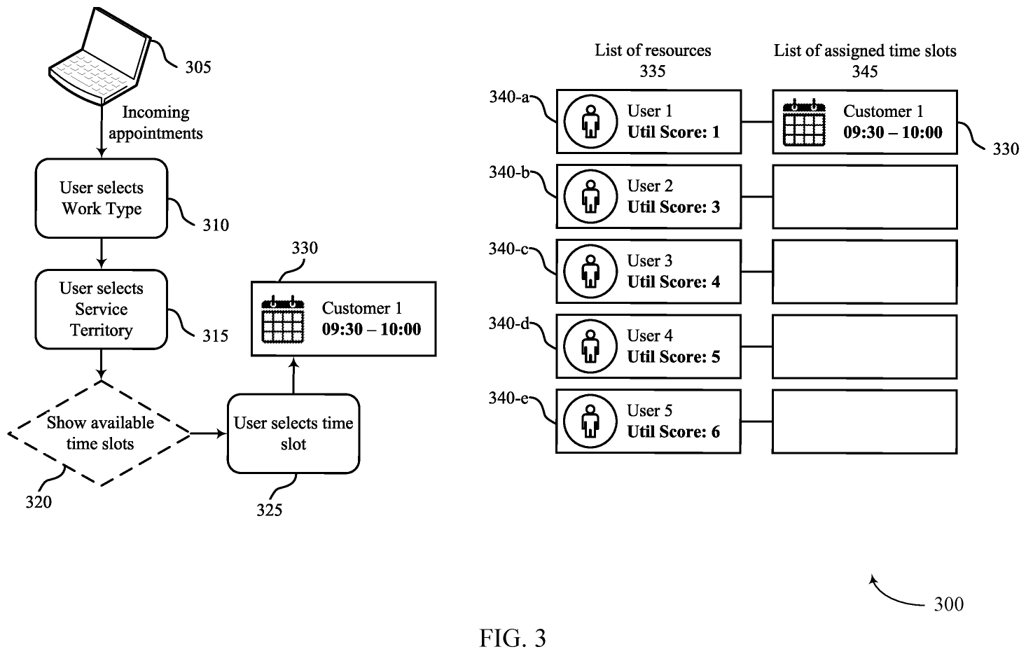

FIG. 3 illustrates an example of an appointment distribution flow 300 that supports precomputing user time resource utilization for querying for appointment distribution in accordance with aspects of the present disclosure. The appointment distribution flow 300 may be implemented by the scheduling platform 210 described herein with reference to FIG. 2. For example, a scheduling platform may follow the appointment distribution flow 300 to calculate utilization scores for a set of users and distribute appointments to users 340 of the set of users.

In some examples, a user (e.g., a customer) may transmit requests to utilize available time resources associated with users 340 for specified time slots via a user device 305. Upon transmitting an incoming appointment request (e.g., to a scheduling platform), at 310, the user (e.g., Customer 1) may select a work type associated with the requested appointment, which may indicate the subject matter of the appointment and what employee skills may be most suited to be assigned the appointment (e.g., an information technology specialist, a human resources representative). At 315, the user may select a service territory associated with the requested appointment, which may indicate a location at which the appointment may be held.

Upon receiving the incoming appointment request including an indication of the work type and the service territory, the scheduling platform may query a data object that stores a set of utilization scores corresponding to the set of users to identify a subset of users having lowest utilization scores compared to the set of users supported by the scheduling platform. In some examples, the scheduling platform may retrieve time slot availability information for the subset of users from a subset of time resource management application instances (e.g., calendar application instances) associated with the subset of users. The time slot availability information may indicate when each user 340 of the subset of users is available for the requested appointment. At 320, based on retrieving the time slot availability information, the scheduling platform may show the customer a list of available time slots for the subset of users (e.g., the times during which each user 340 is available).

At 325, the user may select a time slot 330 for the requested appointment. For example, the user may select the time slot 330 based on how many users are available during that time. In some cases, the user may specify the time slot 330 during which the scheduling platform may schedule the appointment (e.g., from 09:30 to 10:00). The scheduling platform may identify a list of resources 335 corresponding to one or more users 340 from the subset of users that have an available time slot for the specified time slot. As described herein, a user 340 may be referred to as a resource. Each user 340 in the list of resources 335 may correspond to a utilization score, and the user 340 may be listed in ascending order of utilization score. For example, a user 340-a (e.g., User 1) may have a utilization score of 1, a user 340-b (e.g., User 2) may have a utilization score of 3, a user 340-c (e.g., Resource 3) may have a utilization score of 4, a user 340-d (e.g., User 4) may have a utilization score of 5, and a resource 340-e (e.g., User 5) may have a utilization score of 6, and so on. In some examples, the user or the scheduling platform may determine how many users 340 to include in the list of resources 335. As such, the list of resources 335 may include more or fewer users 340 than shown in the example of FIG. 3. The users 340 in the list of resources 335 may have the lowest utilization scores relative to all of the users 340 using the scheduling platform. For example, the scheduling platform may support one thousand users 340, and the subset of users (e.g., included in the list of resources 335) may include the five users 340 with the lowest utilization scores.

Upon identifying the time slot availability information, the scheduling platform may identify a list of assigned time slots 345. That is, the scheduling platform may begin assigning requested appointments based on the utilization scores of the subset of users (e.g., the users 340 in the list of resources 335). The scheduling platform may assign the time slot 330 (e.g., corresponding to the requested appointment) to the user 340 in the list of resources 335 that has the lowest utilization score and is available during the time slot 330. In the example of FIG. 3, the scheduling platform may assign the appointment to the user 340-a, which has the lowest utilization score (e.g., 1), as long as the user 340-a is available during the time slot 330. If the user 340-a is unavailable during the time slot 330, then the appointment may be assigned to the user 340 with the next lowest utilization score that is available during the time slot 330. For example, the appointment may be assigned to the user 340-b if the user 340-a is unavailable and the user 340-b is available during the time slot 330.

In some cases, the scheduling platform may update the utilization scores for the users 340 in the list of resources 335 based on assigning the time slot 330 to the user 340-a. That is, because the user 340-a now has an appointment scheduled during the time slot 330, the user 340-a has a higher utilization score (e.g., less availability) during a particular time period (e.g., a day, a week, a month, or a parameter-based duration).

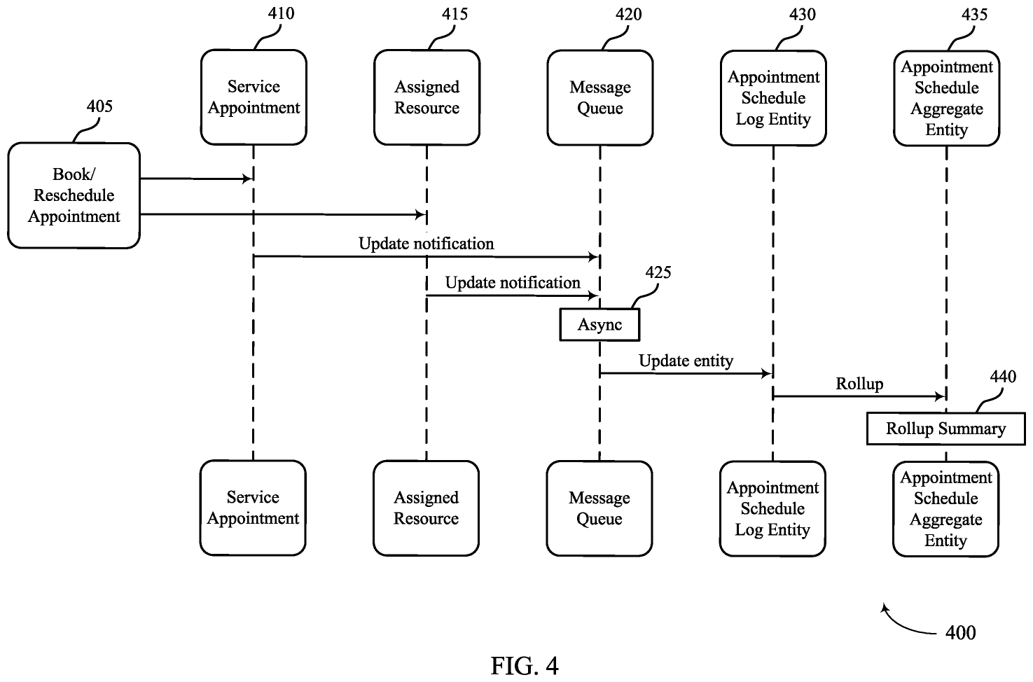

FIG. 4 illustrates an example of a utilization score calculation 400 that supports precomputing user time resource utilization for querying for appointment distribution in accordance with aspects of the present disclosure. The utilization score calculation 400 may be implemented by the utilization score logic 220 of the scheduling platform 210 described herein with reference to FIG. 2. For example, a scheduling platform may use the utilization score calculation 400 to calculate utilization scores corresponding to different users of an organization, which may indicate an aggregation of unavailable time resources corresponding to a configured time period for a user.

As described herein, the utilization score calculation 400 may be an asynchronous process that tracks service appointments and assigned users and time resources. A scheduling platform may precompute utilization scores of a set of users supported by the scheduling platform (e.g., each user having time resources) for querying for appointment distribution. The utilizations scores may store information about a current capacity of time resources that may already be booked (e.g., leaving them unavailable for scheduling). The scheduling platform may reduce the set of users to a subset of users with the lowest utilization scores compared to the set of users, which may improve efficiency and reduce computational intensity as the scheduling platform may apply the load balancing calculation to the subset of users rather than the full set of users, and assign an appointment to a user to from the subset of user rather than from the full set of users.

The utilization score calculation 400 may begin at 405, when a scheduling platform receives a request to book or reschedule an appointment with a user of the organization (e.g., an employee) and a time resource corresponding to the user. At 410, a service appointment corresponding to the request may be created, and at 415, a user may be assigned to the service appointment (e.g., the service appointment may be assigned to a user at a particular time, using a corresponding available time resource). The utilization score of a user may be automatically updated when a service appointment is created or updated at 405 for that user. Accordingly, an update notification may be sent to a message queue at 420 indicating the updated service appointment. The message queue may include a message handling system that processes service appointments asynchronously at 425.

The scheduling platform may use the message queue to populate data in an appointment schedule log entity at 430 (e.g., update an entity). The appointment schedule log entity may store transactional details about service appointments, calendar events, and resource absence of a particular service resource, and the records of the appointment schedule log entity may be associated with any service territory. In some examples, the scheduling platform may generate an appointment schedule log entity (e.g., a transaction table) for each service appointment against a service resource. The appointment schedule log entity may indicate a particular service resource, a date on which the service resource was added or updated, time resource utilization information, one or more related records, one or more parent records (e.g., a parent record identifier), a service territory, a work type, or any combination thereof. In addition, the appointment schedule log entity may include a consideration field indicating whether the particular service resource is to be included in the utilization score calculation 400 (e.g., an “Is Considered” field).

At 435, when a record for a particular service appointment is added to the appointment schedule log entity, the record is added into an appointment schedule aggregate entity. The appointment schedule aggregate entity may aggregate appointment schedule log entities for different service resources. For example, an appointment schedule aggregate entity may hold the busy time of a user on a daily basis, and a rollup summary 435 field (e.g., in minutes) may be created from the appointment schedule log entity to store the total busy time of a user. The appointment schedule aggregate entity may be queried by the scheduling platform to execute a load balancing logic (e.g., or custom logic) used to calculate the utilization scores of each service resource over a configured time period. As such, the appointment schedule aggregate entity may include a rollup summary 435 indicating a full utilization of a service resource during a particular configured time period (e.g., a day, a week, a month). Put another way, the appointment schedule aggregate entity may include the day-to-day utilization of each user and each users' time resources.

In an example, a service appointment may be booked with multiple users (e.g., multiple assigned resources). The scheduling platform may create a message in the message queue for each service appointment, and the message queue may process the service appointment asynchronously and create an entry in the appointment schedule log entity corresponding to each assigned user. For example, the service appointment may be assigned to two user (e.g., two attendees), a first user and a second user, for a sixty-minute duration on a given date. Upon processing the messages from the message queue, the appointment schedule log entity may create two records, one for each of the first user and the second user. In some examples, the first user may already have four hours of meetings scheduled on the given date, and the second user may already have three hours of meetings scheduled on the given date, where this time resource utilization information may be stored in appointment schedule aggregate entities corresponding to each user.

Upon inserting the new records into the appointment schedule log entities, the records (e.g., the time resource utilization information) may be aggregated into the respective appointment schedule aggregate entities. Accordingly, the utilization of the first user may increase from four hours to five hours (e.g., because the new sixty-minute appointment was added), and the utilization of the second user may increase from three hours to four hours. As such, the appointment schedule aggregate entities may store the time resource utilization information for each user, and the scheduling platform may query the appointment schedule aggregate entities, run a load balancing logic on the data stored in the appointment schedule aggregate entities, and calculate the utilization scores of each user accordingly. In addition, the utilization scores may be recalculated each time a service appointment is added or updated.

In some examples, a user may customize the appointment schedule log entity using the consideration field to indicate that a particular user or time resource may be omitted from the appointment schedule aggregate entity and the rollup summary 440. For example, an appointment schedule aggregate entity may include ten records, however only seven records may be flagged to be considered in the consideration field of the appointment schedule log entity. As such, the seven records may be considered in the utilization score calculation 400 and the remaining three records may be ignored. In another example, a user may be scheduled for two, thirty-minute appointments and one, thirty-minute event on a given day. If both of the appointments and the event are flagged to be considered, then the utilization score of the user may be ninety minutes. However, the event (e.g., a calendar event which may not be scheduled with other resources) may be excluded (e.g., not considered) for the utilization score calculation 400, and as such, the utilization score of the user may be sixty minutes. As such, a user may determine what scheduled activities (e.g., service appointments, events, and the like) are included in the utilization score calculation 400 using different filtering fields (e.g., NPSs, type of appointment, etc.).

In some cases, the scheduling platform may use an appointment assignment resource pool entity to manage a set of users for which a specific policy may be applied. The appointment assignment resource pool entity may include a lookup for an appointment assignment policy setup entity, an entity specifying a service territory member, or both. The appointment assignment resource pool entity may be used to define the set of users for which a specific policy may be applicable.

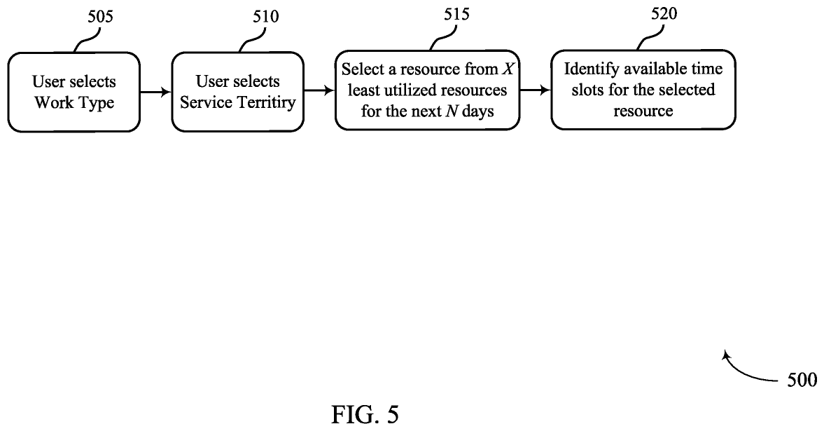

FIG. 5 illustrates an example of a process flow 500 that supports precomputing user time resource utilization for querying for appointment distribution in accordance with aspects of the present disclosure. The process flow 500 may be implemented by a user of an organization (e.g., an end user, an employee) to identify appointment slots using appointment distribution. For example, the user may implement the process flow 500 using a scheduling platform to determine a subset of users with least utilized time resources and identify time slots during which the subset of users have available time resources.

At 505, the user may select a work type corresponding to an appointment requested by a customer. The work type may correspond to what skills and type of employee may be most suited to handle the appointment (e.g., if the meeting is about technical support, an information technology employee may be most suited). At 510, the user may select a service territory corresponding to the requested appointment. The service territory may indicate a particular location where the appointment may be held. In addition, the service territory may indicate a particular time period during which an employee may be available in that service territory (e.g., 9:00 am to 5:00 pm).

At 515, based on selecting the work type and the service territory, the user may use the scheduling platform to identify a quantity of X least utilized users (e.g., resources) for the next N days, where the X least utilized users are a subset of X users from a set of T users associated with the selected work type and the selected service territory. The user may identify the X least utilized users over a 14-day period, however the time period may also span a week, a month, or a parameter-based duration. In some examples, as described with reference to FIG. 4, the user may aggregate the overall utilization of each user of the subset of users into an appointment schedule aggregate entity for the next N days, and determine the X least utilized users (e.g., 10 users) from the appointment schedule aggregate entity. The user may then select a user from the X least utilized users with which to schedule the appointment For example, the user may select a user with a lowest utilization score from the X least utilized users.

At 520, the user may use the scheduling platform to identify a list of available time slots for a selected user from the X least utilized users. That is, the scheduling platform may display the available time slots for the selected user. In some examples, the list may indicate which user of the X least utilized users each available time slot corresponds to, or the list may be anonymous. Additionally, the list indicating the available time slots may be based on time resource utilization information retrieved from a time resource management application instance corresponding to each of the X least utilized users. In some examples, the user may assign the appointment to a user of the X least utilized users during one of the available time slots.

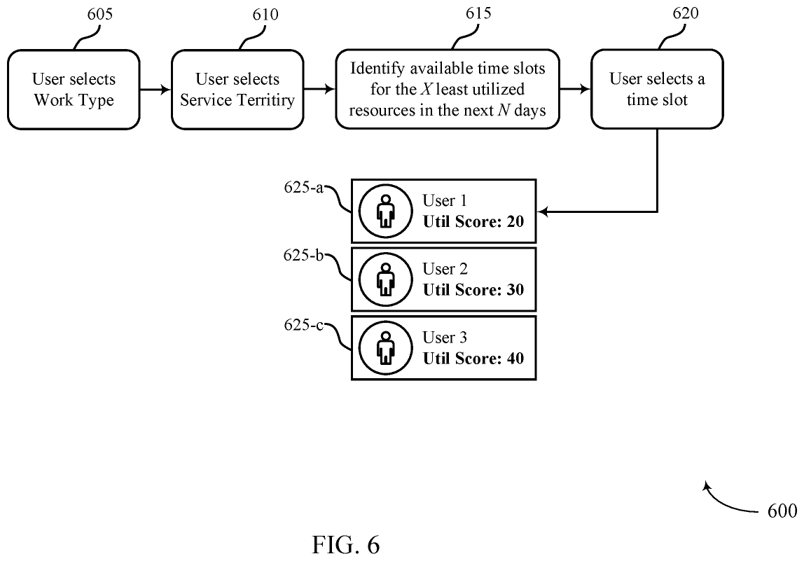

FIG. 6 illustrates an example of a process flow 600 that supports precomputing user time resource utilization for querying for appointment distribution in accordance with aspects of the present disclosure. The process flow 600 may be implemented by a user of an organization (e.g., an end user, an employee) to identify assign or schedule appointments using appointment distribution. For example, the user may implement the process flow 600 using a scheduling platform to identify a subset of users with least utilized time resources and select a time slot during which to schedule an appointment with a user 625 (e.g., a resource) of the subset of users supported by the scheduling platform.

At 605, the user may select a work type corresponding to an appointment requested by a customer. The work type may correspond to what skills and type of employee may be most suited to handle the appointment (e.g., if the meeting is about technical support, an information technology employee may be most suited). At 610, the user may select a service territory corresponding to the requested appointment. The service territory may indicate a particular location where the appointment may be held. In addition, the service territory may indicate a particular time period during which an employee may be available in that service territory (e.g., 9:00 am to 5:00 pm).

At 615, the user may identify a list of available time slots (e.g., time slots during which to schedule the appointment) for a quantity of X least utilized users for the next N days. For example, the scheduling platform may display a list, to the user, that indicates all of the available time slots for each of the X least utilized users over the next N days. The X least utilized users may include a subset of X users from a set of T users associated with the selected work type and the selected service territory. The user may identify the X least utilized users (e.g., resources) over a 14-day period, however the time period may also span a week, a month, or a parameter-based duration. In addition, the X least utilized users may have the lowest utilization scores of the set of T users supported associated with the selected work type and the selected service territory. For example, the X least utilized users may include a user 625-a (e.g., User 1) with a utilization score of 20, a user 625-b (e.g., User 2) with a utilization score of 30, and a user 625-c (e.g., User 3) with a utilizations score of 40, which may be the users 625 with the lowest utilization scores of all the users 625 in the set of T users. In some examples, the list of available time slots may include all time slots during which the user 625-a, the user 625-b, or the user 625-b are available. In some other examples, the list of available time slots may include time slots during which all of the users 625 of the X least utilized users (e.g., the user 625-a, the user 625-b, and the user 625-c) are available. The list of available time slots may be sorted based utilization score, such that available time slots corresponding to the least utilized user (e.g., the user 625-a) are shown first, followed by the available time slots corresponding to the user 625-b and the user 625-c, or the list of available time slots may be sorted chronologically, such that the earliest available time slots are shown first regardless of the utilization score of the corresponding user 625.

At 620, the user may select an available time slot during which to schedule the requested appointment (e.g., the user may assign the appointment to a user 625 with an available time resource). In some examples, the user may automatically assign a service resource. For example, the list of available time slots may indicate available time slots for all of the X least utilized users (e.g., the user 625-a, the user 625-b, the user 625-c) anonymously (e.g., without indicating which user 625 is associated with which available time slot). The user may select a time slot. Accordingly, the user may assign the appointment the least utilized user from that list (e.g., the user 625-a). In some other examples, the user may directly select a user 625 from the X least utilized users (e.g., the user may select a service resource) to assign the appointment to. For example, the user may be shown a list of the X least utilized users, the user may select a user 625 from the list of X least utilized users (e.g., the least utilized user), and then the user may be shown a list of available time slots corresponding to the selected user 625. As such, the user may select an available time resource corresponding to the selected user 625 and assign an appointment to the selected user 625 and during the selected available time slot. In some cases, the utilization score of the selected user 625 (e.g., the user 625-a) may increase to reflect the newly scheduled appointment.

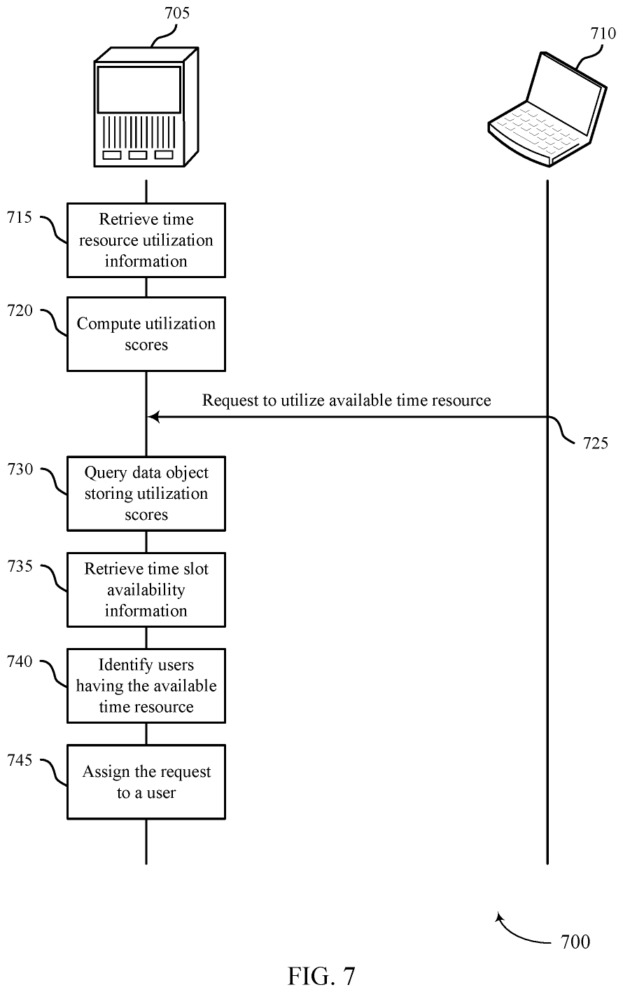

FIG. 7 illustrates an example of a process flow 700 that supports precomputing user time resource utilization for querying for appointment distribution in accordance with aspects of the present disclosure. The process flow 700 may implement aspects of the data processing system 100 or the computing architecture 200, or may be implemented by the data processing system 100 or the computing architecture 200 as described with reference to FIGS. 1 and 2. The process flow 700 may include a scheduling platform 705 and a user device 710. In the following description of the process flow 700, the operations between the scheduling platform 705 and the user device 710 may be performed in different orders or at different times. Some operations may also be left out of the process flow 700, or other operations may be added. Although the scheduling platform 705 and the user device 710 are shown performing the operations of the process flow 700, some aspects of some operations may be performed by one or more other devices.

At 715, the scheduling platform 705 may retrieve time resource utilization information for a set of users from a set of time resource management application instances associated with the users, where the time resource utilization information may indicate unavailable time resources for users of the set of users for a configured time period. That is, the time resource utilization information may indicate the busyness of users in terms of a quantity of meetings or a quantity of hours over a particular time period. In some examples, the time resource management application instances may include calendar applications, scheduling applications, personal information applications, or any other application used to schedule appointments and events.

At 720, based on retrieving the time resource utilization information, the scheduling platform 705 may compute a set of utilization scores for the set of users, where a utilization score includes an aggregation of unavailable time resources corresponding to the configured time period for a user of the set of users. The utilization score may be in terms of a number of meetings or a number of hours booked during the configured time period. For example, the utilization score may indicate that a user has five meetings booked over a one week duration.

At 725, the scheduling platform 705 may receive, from a user (e.g., a customer) via the user device 710, a request to utilize an available time resource for a specified time slot. Put another way, the scheduling platform 705 may receive a request to assign an appointment to a user that is available during the specified time slot. In some examples, the request may also indicate a work type and a service territory associated with the appointment.

At 730, the scheduling platform 705 may query a data object storing the set of utilization scores to identify a subset of users of the set of users having a lowest utilization score. In some examples, the data object may include an appointment schedule aggregate entity that aggregates utilization scores of the set of users for the configured time period in a table. The subset of users may include users that have the lowest utilization scores compared to the rest of the set of users (e.g., the least utilized users).

At 735, the scheduling platform 705 may retrieve time slot availability information corresponding to the configured time period for the subset of users from a subset of time resource management application instances associated with the subset of users. The time slot availability information may indicate what time resources each user of the subset of users are available. As such, the scheduling platform 705 may retrieve the time slot availability information for the subset of users rather than the full set of users, which may reduce computational complexity and increase efficiency.

At 740, the scheduling platform 705 may identify one or more users from the subset of users having the available time resource for the specified time slot. That is, the scheduling platform 705 may identify that one or more users may be assigned the requested appointment based on being available during the specified time slot.

At 745, the scheduling platform 705 may assign the request to a user of the subset of users based on a load balancing logic and the plurality of utilization scores. For example, the scheduling platform 705 may assign the appointment to the user with the lowest utilization score that is also available for the specified time slot. In addition, the scheduling platform 705 may apply a load balancing logic or a different algorithm (e.g., a user-defined logic) to determine which user to assign the appointment to if the users are all available and have similar utilization scores.

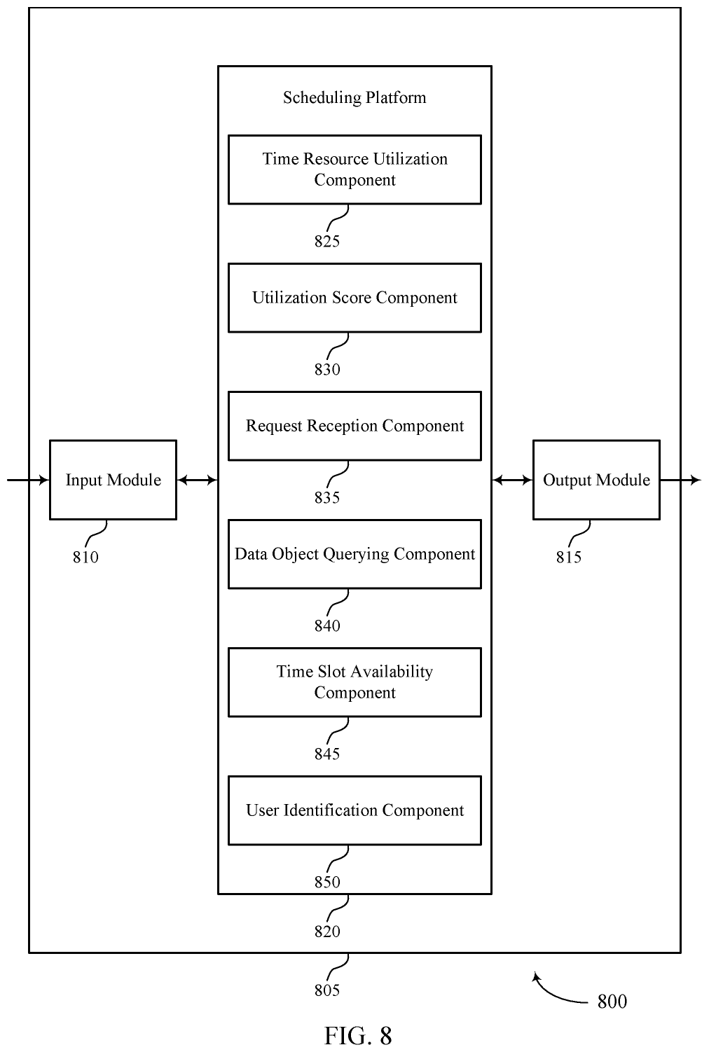

FIG. 8 shows a block diagram 800 of a device 805 that supports precomputing user time resource utilization for querying for appointment distribution in accordance with aspects of the present disclosure. The device 805 may include an input module 810, an output module 815, and a scheduling platform 820. The device 805 may also include a processor. Each of these components may be in communication with one another (e.g., via one or more buses).

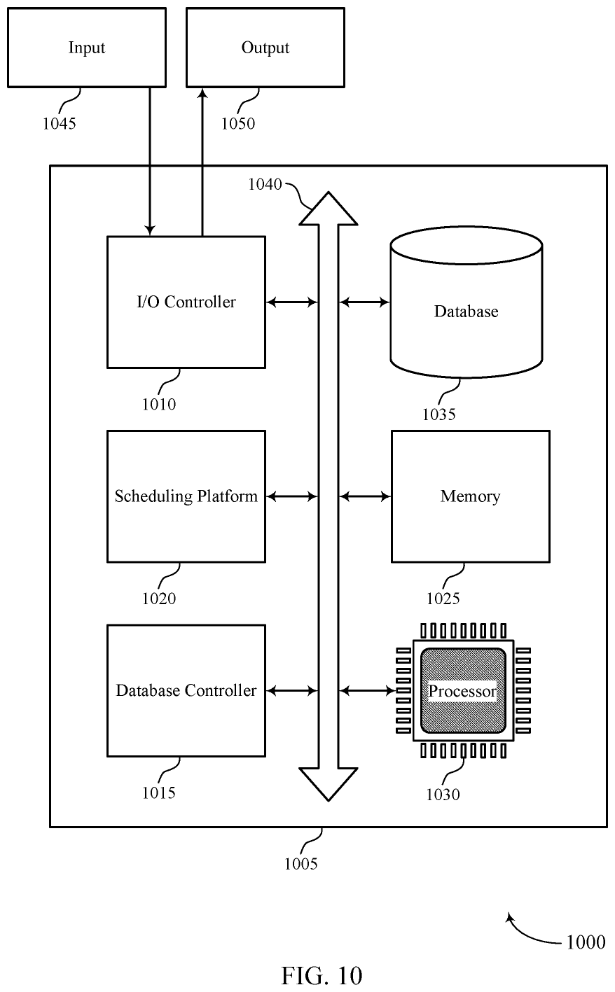

The input module 810 may manage input signals for the device 805. For example, the input module 810 may identify input signals based on an interaction with a modem, a keyboard, a mouse, a touchscreen, or a similar device. These input signals may be associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the device 805 for processing. For example, the input module 810 may transmit input signals to the scheduling platform 820 to support precomputing user time resource utilization for querying for appointment distribution. In some cases, the input module 810 may be a component of an I/O controller 1010 as described with reference to FIG. 10.

The output module 815 may manage output signals for the device 805. For example, the output module 815 may receive signals from other components of the device 805, such as the scheduling platform 820, and may transmit these signals to other components or devices. In some examples, the output module 815 may transmit output signals for display in a user interface, for storage in a database or data store, for further processing at a server or server cluster, or for any other processes at any number of devices or systems. In some cases, the output module 815 may be a component of an I/O controller 1010 as described with reference to FIG. 10.

For example, the scheduling platform 820 may include a time resource utilization component 825, a utilization score component 830, a request reception component 835, a data object querying component 840, a time slot availability component 845, a user identification component 850, or any combination thereof. In some examples, the scheduling platform 820, or various components thereof, may be configured to perform various operations (e.g., receiving, monitoring, transmitting) using or otherwise in cooperation with the input module 810, the output module 815, or both. For example, the scheduling platform 820 may receive information from the input module 810, send information to the output module 815, or be integrated in combination with the input module 810, the output module 815, or both to receive information, transmit information, or perform various other operations as described herein.

The scheduling platform 820 may support data processing in accordance with examples as disclosed herein. The time resource utilization component 825 may be configured as or otherwise support a means for retrieving time resource utilization information for a plurality of users from a plurality of time resource management application instances associated with the plurality of users, wherein the time resource utilization information indicates unavailable time resources for users of the plurality of users for a configured time period. The utilization score component 830 may be configured as or otherwise support a means for computing a plurality of utilization scores for the plurality of users based at least in part on the retrieving, wherein a utilization score comprises an aggregation of unavailable time resources corresponding to the configured time period for a user of the plurality of users. The request reception component 835 may be configured as or otherwise support a means for receiving a request to utilize an available time resource for a specified time slot. The data object querying component 840 may be configured as or otherwise support a means for querying a data object storing the plurality of utilization scores to identify a subset of users of the plurality of users having a lowest utilization score. The time slot availability component 845 may be configured as or otherwise support a means for retrieving, from a subset of time resource management application instances associated with the subset of users and in response to the querying, time slot availability information corresponding to the configured time period for the subset of users. The user identification component 850 may be configured as or otherwise support a means for identifying one or more users from the subset of users having the available time resource for the specified time slot.

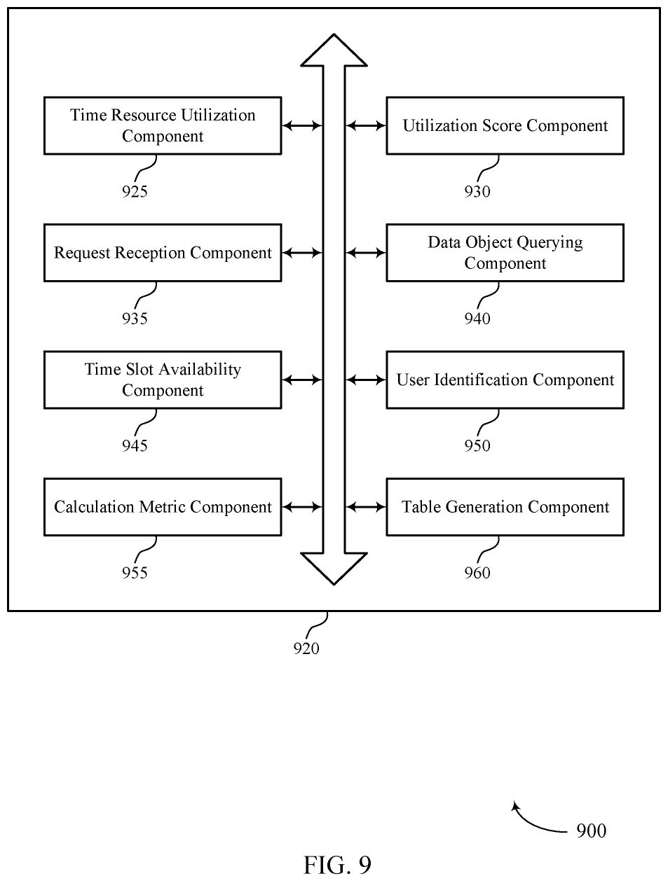

FIG. 9 shows a block diagram 900 of a scheduling platform 920 that supports precomputing user time resource utilization for querying for appointment distribution in accordance with aspects of the present disclosure. The scheduling platform 920 may be an example of aspects of a scheduling platform or a scheduling platform 820, or both, as described herein. The scheduling platform 920, or various components thereof, may be an example of means for performing various aspects of precomputing user time resource utilization for querying for appointment distribution as described herein. For example, the scheduling platform 920 may include a time resource utilization component 925, a utilization score component 930, a request reception component 935, a data object querying component 940, a time slot availability component 945, a user identification component 950, a calculation metric component 955, a table generation component 960, or any combination thereof. Each of these components may communicate, directly or indirectly, with one another (e.g., via one or more buses).

The scheduling platform 920 may support data processing in accordance with examples as disclosed herein. The time resource utilization component 925 may be configured as or otherwise support a means for retrieving time resource utilization information for a plurality of users from a plurality of time resource management application instances associated with the plurality of users, wherein the time resource utilization information indicates unavailable time resources for users of the plurality of users for a configured time period. The utilization score component 930 may be configured as or otherwise support a means for computing a plurality of utilization scores for the plurality of users based at least in part on the retrieving, wherein a utilization score comprises an aggregation of unavailable time resources corresponding to the configured time period for a user of the plurality of users. The request reception component 935 may be configured as or otherwise support a means for receiving a request to utilize an available time resource for a specified time slot. The data object querying component 940 may be configured as or otherwise support a means for querying a data object storing the plurality of utilization scores to identify a subset of users of the plurality of users having a lowest utilization score. The time slot availability component 945 may be configured as or otherwise support a means for retrieving, from a subset of time resource management application instances associated with the subset of users and in response to the querying, time slot availability information corresponding to the configured time period for the subset of users. The user identification component 950 may be configured as or otherwise support a means for identifying one or more users from the subset of users having the available time resource for the specified time slot.

In some examples, the calculation metric component 955 may be configured as or otherwise support a means for receiving a user input indicating a user configuration defining a calculation metric for computing the plurality of utilization scores. In some examples, the calculation metric comprises a total number of unavailable hours during to the configured time period or a total number of meetings scheduled during the configured time period.

In some examples, to support computing the plurality of utilization scores, the calculation metric component 955 may be configured as or otherwise support a means for identifying the aggregation of unavailable time resources corresponding to the configured time period for the user of the plurality of users based at least in part on the calculation metric.

In some examples, the calculation metric component 955 may be configured as or otherwise support a means for assigning the request to a user of the subset of users based at least in part on a load balancing logic and the plurality of utilization scores.

In some examples, the calculation metric component 955 may be configured as or otherwise support a means for updating the plurality of utilization scores for the one or more users from the subset of users identified as having the available time resource for the specified time slot based at least in part on the assigning.

In some examples, to support querying the data object, the data object querying component 940 may be configured as or otherwise support a means for querying the data object storing the plurality of utilization scores to identify a subset of users of the plurality of users having a subset of lowest utilization scores relative to the plurality of users.

In some examples, a time resource management application instance comprises a calendar application, an appointment scheduler application, a personal information management application, or any combination thereof. In some examples, a utilization score indicates a total number of unavailable hours during to the configured time period or a total number of meetings scheduled during the configured time period.

In some examples, to support receiving the request, the request reception component 935 may be configured as or otherwise support a means for receiving the request to utilize the available time resource for the specified time slot, wherein the request comprises an indication of a work type, a service territory, or both corresponding to the available time resource.

In some examples, the request reception component 935 may be configured as or otherwise support a means for querying the data object storing the plurality of utilization scores to identify a subset of users of the plurality of users having a lowest utilization score and corresponding to the work type, the service territory, or both based at least in part on the receiving.

In some examples, the table generation component 960 may be configured as or otherwise support a means for generating a table storing the time resource utilization information for a user from a time resource management application instance associated with the user, wherein the time resource utilization information indicates unavailable time resources for the user for a configured time period, one or more related records, a parent record, a work type, a service territory, or any combination thereof.

FIG. 10 shows a diagram of a system 1000 including a device 1005 that supports precomputing user time resource utilization for querying for appointment distribution in accordance with aspects of the present disclosure. The device 1005 may be an example of or include the components of a device 805 as described herein. The device 1005 may include components for bi-directional data communications including components for transmitting and receiving communications, such as a scheduling platform 1020, an I/O controller 1010, a database controller 1015, a memory 1025, a processor 1030, and a database 1035. These components may be in electronic communication or otherwise coupled (e.g., operatively, communicatively, functionally, electronically, electrically) via one or more buses (e.g., a bus 1040).

The I/O controller 1010 may manage input signals 1045 and output signals 1050 for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In other cases, the I/O controller 1010 may represent or interact with a modem, a keyboard, a mouse, a touchscreen, or a similar device. In some cases, the I/O controller 1010 may be implemented as part of a processor 1030. In some examples, a user may interact with the device 1005 via the I/O controller 1010 or via hardware components controlled by the I/O controller 1010.

The database controller 1015 may manage data storage and processing in a database 1035. In some cases, a user may interact with the database controller 1015. In other cases, the database controller 1015 may operate automatically without user interaction. The database 1035 may be an example of a single database, a distributed database, multiple distributed databases, a data store, a data lake, or an emergency backup database.

Memory 1025 may include random-access memory (RAM) and ROM. The memory 1025 may store computer-readable, computer-executable software including instructions that, when executed, cause the processor 1030 to perform various functions described herein. In some cases, the memory 1025 may contain, among other things, a BIOS which may control basic hardware or software operation such as the interaction with peripheral components or devices.

The processor 1030 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in a memory 1025 to perform various functions (e.g., functions or tasks supporting precomputing user time resource utilization for querying for appointment distribution).

The scheduling platform 1020 may support data processing in accordance with examples as disclosed herein. For example, the scheduling platform 1020 may be configured as or otherwise support a means for retrieving time resource utilization information for a plurality of users from a plurality of time resource management application instances associated with the plurality of users, wherein the time resource utilization information indicates unavailable time resources for users of the plurality of users for a configured time period. The scheduling platform 1020 may be configured as or otherwise support a means for computing a plurality of utilization scores for the plurality of users based at least in part on the retrieving, wherein a utilization score comprises an aggregation of unavailable time resources corresponding to the configured time period for a user of the plurality of users. The scheduling platform 1020 may be configured as or otherwise support a means for receiving a request to utilize an available time resource for a specified time slot. The scheduling platform 1020 may be configured as or otherwise support a means for querying a data object storing the plurality of utilization scores to identify a subset of users of the plurality of users having a lowest utilization score. The scheduling platform 1020 may be configured as or otherwise support a means for retrieving, from a subset of time resource management application instances associated with the subset of users and in response to the querying, time slot availability information corresponding to the configured time period for the subset of users. The scheduling platform 1020 may be configured as or otherwise support a means for identifying one or more users from the subset of users having the available time resource for the specified time slot.

By including or configuring the scheduling platform 1020 in accordance with examples as described herein, the device 1005 may support techniques for precomputing user time resource utilization for querying for appointment distribution, which may increase efficiency, increase user satisfaction, and decrease workflow inefficiencies by reducing a set of users to a subset of users before distributing appointments. As such, appointment distribution may use fewer computational resources and increase the efficiency and effectiveness scheduling appointments.

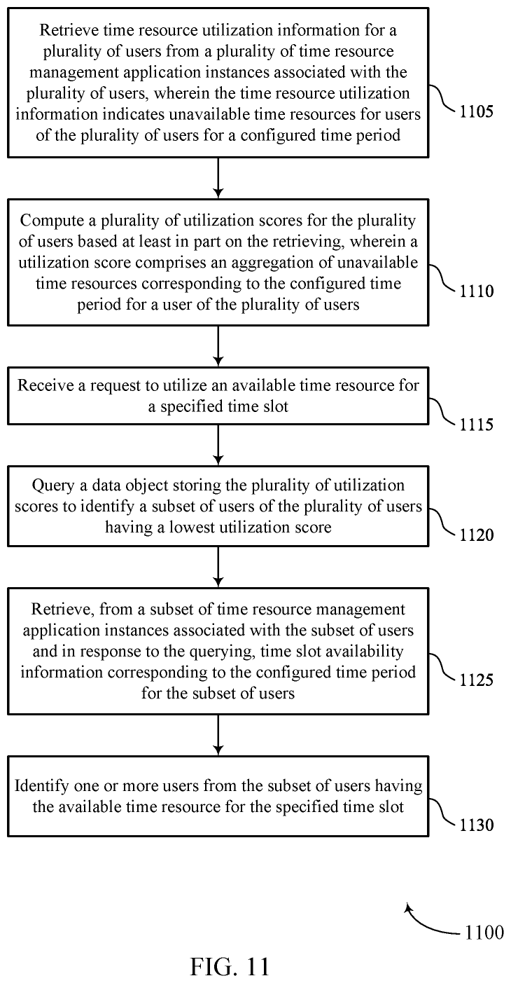

FIG. 11 shows a flowchart illustrating a method 1100 that supports precomputing user time resource utilization for querying for appointment distribution in accordance with aspects of the present disclosure. The operations of the method 1100 may be implemented by a server (e.g., an application server, a database server, a cluster, or the like) or its components as described herein. For example, the operations of the method 1100 may be performed by a server as described with reference to FIGS. 1 through 10. In some examples, a server may execute a set of instructions to control the functional elements of the server to perform the described functions. Additionally or alternatively, the server may perform aspects of the described functions using special-purpose hardware.

At 1105, the method may include retrieving time resource utilization information for a plurality of users from a plurality of time resource management application instances associated with the plurality of users, wherein the time resource utilization information indicates unavailable time resources for users of the plurality of users for a configured time period. The operations of 1105 may be performed in accordance with examples as disclosed herein. In some examples, aspects of the operations of 1105 may be performed by a time resource utilization component 925 as described with reference to FIG. 9.

At 1110, the method may include computing a plurality of utilization scores for the plurality of users based at least in part on the retrieving, wherein a utilization score comprises an aggregation of unavailable time resources corresponding to the configured time period for a user of the plurality of users. The operations of 1110 may be performed in accordance with examples as disclosed herein. In some examples, aspects of the operations of 1110 may be performed by a utilization score component 930 as described with reference to FIG. 9.

At 1115, the method may include receiving a request to utilize an available time resource for a specified time slot. The operations of 1115 may be performed in accordance with examples as disclosed herein. In some examples, aspects of the operations of 1115 may be performed by a request reception component 935 as described with reference to FIG. 9.

At 1120, the method may include querying a data object storing the plurality of utilization scores to identify a subset of users of the plurality of users having a lowest utilization score. The operations of 1120 may be performed in accordance with examples as disclosed herein. In some examples, aspects of the operations of 1120 may be performed by a data object querying component 940 as described with reference to FIG. 9.

At 1125, the method may include retrieving, from a subset of time resource management application instances associated with the subset of users and in response to the querying, time slot availability information corresponding to the configured time period for the subset of users. The operations of 1125 may be performed in accordance with examples as disclosed herein. In some examples, aspects of the operations of 1125 may be performed by a time slot availability component 945 as described with reference to FIG. 9.

At 1130, the method may include identifying one or more users from the subset of users having the available time resource for the specified time slot. The operations of 1130 may be performed in accordance with examples as disclosed herein. In some examples, aspects of the operations of 1130 may be performed by a user identification component 950 as described with reference to FIG. 9.

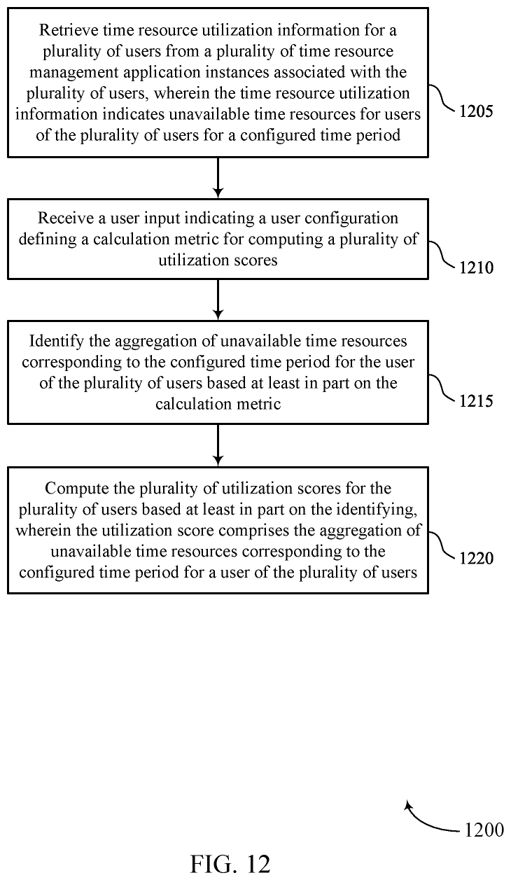

FIG. 12 shows a flowchart illustrating a method 1200 that supports precomputing user time resource utilization for querying for appointment distribution in accordance with aspects of the present disclosure. The operations of the method 1200 may be implemented by a server (e.g., an application server, a database server, a cluster, or the like) or its components as described herein. For example, the operations of the method 1200 may be performed by a server as described with reference to FIGS. 1 through 10. In some examples, a server may execute a set of instructions to control the functional elements of the server to perform the described functions. Additionally or alternatively, the server may perform aspects of the described functions using special-purpose hardware.

At 1205, the method may include retrieving time resource utilization information for a plurality of users from a plurality of time resource management application instances associated with the plurality of users, wherein the time resource utilization information indicates unavailable time resources for users of the plurality of users for a configured time period. The operations of 1205 may be performed in accordance with examples as disclosed herein. In some examples, aspects of the operations of 1205 may be performed by a time resource utilization component 925 as described with reference to FIG. 9.

At 1210, the method may include receiving a user input indicating a user configuration defining a calculation metric for computing a plurality of utilization scores. The operations of 1210 may be performed in accordance with examples as disclosed herein. In some examples, aspects of the operations of 1210 may be performed by a calculation metric component 955 as described with reference to FIG. 9.

At 1215, the method may include identifying an aggregation of unavailable time resources corresponding to the configured time period for the user of the plurality of users based at least in part on the calculation metric. The operations of 1215 may be performed in accordance with examples as disclosed herein. In some examples, aspects of the operations of 1215 may be performed by a calculation metric component 955 as described with reference to FIG. 9.

At 1220, the method may include computing the plurality of utilization scores for the plurality of users based at least in part on the retrieving, wherein a utilization score comprises the aggregation of unavailable time resources corresponding to the configured time period for a user of the plurality of users. The operations of 1220 may be performed in accordance with examples as disclosed herein. In some examples, aspects of the operations of 1220 may be performed by a utilization score component 930 as described with reference to FIG. 9.

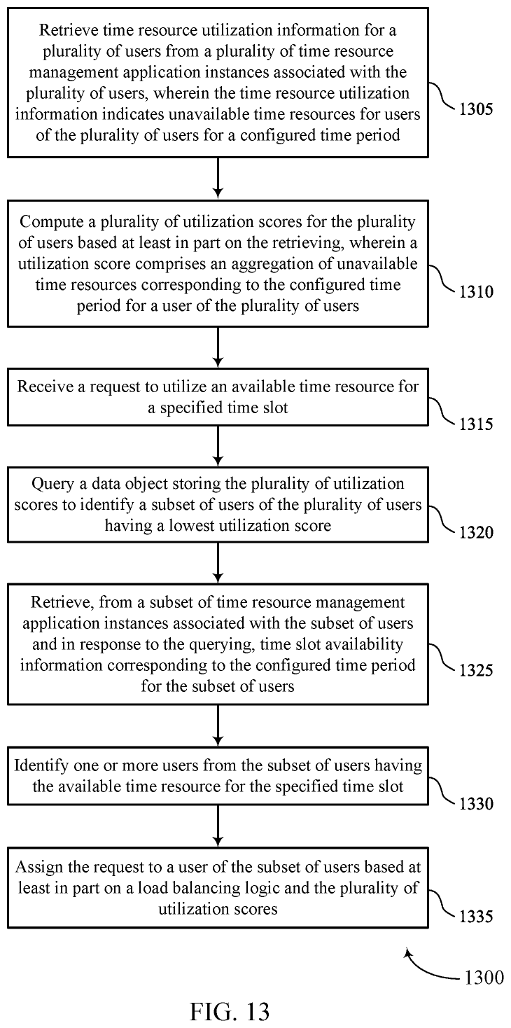

FIG. 13 shows a flowchart illustrating a method 1300 that supports precomputing user time resource utilization for querying for appointment distribution in accordance with aspects of the present disclosure. The operations of the method 1300 may be implemented by a server (e.g., an application server, a database server, a cluster, or the like) or its components as described herein. For example, the operations of the method 1300 may be performed by a server as described with reference to FIGS. 1 through 10. In some examples, a server may execute a set of instructions to control the functional elements of the server to perform the described functions. Additionally or alternatively, the server may perform aspects of the described functions using special-purpose hardware.

At 1305, the method may include retrieving time resource utilization information for a plurality of users from a plurality of time resource management application instances associated with the plurality of users, wherein the time resource utilization information indicates unavailable time resources for users of the plurality of users for a configured time period. The operations of 1305 may be performed in accordance with examples as disclosed herein. In some examples, aspects of the operations of 1305 may be performed by a time resource utilization component 925 as described with reference to FIG. 9.

At 1310, the method may include computing a plurality of utilization scores for the plurality of users based at least in part on the retrieving, wherein a utilization score comprises an aggregation of unavailable time resources corresponding to the configured time period for a user of the plurality of users. The operations of 1310 may be performed in accordance with examples as disclosed herein. In some examples, aspects of the operations of 1310 may be performed by a utilization score component 930 as described with reference to FIG. 9.

At 1315, the method may include receiving a request to utilize an available time resource for a specified time slot. The operations of 1315 may be performed in accordance with examples as disclosed herein. In some examples, aspects of the operations of 1315 may be performed by a request reception component 935 as described with reference to FIG. 9.

At 1320, the method may include querying a data object storing the plurality of utilization scores to identify a subset of users of the plurality of users having a lowest utilization score. The operations of 1320 may be performed in accordance with examples as disclosed herein. In some examples, aspects of the operations of 1320 may be performed by a data object querying component 940 as described with reference to FIG. 9.

At 1325, the method may include retrieving, from a subset of time resource management application instances associated with the subset of users and in response to the querying, time slot availability information corresponding to the configured time period for the subset of users. The operations of 1325 may be performed in accordance with examples as disclosed herein. In some examples, aspects of the operations of 1325 may be performed by a time slot availability component 945 as described with reference to FIG. 9.

At 1330, the method may include identifying one or more users from the subset of users having the available time resource for the specified time slot. The operations of 1330 may be performed in accordance with examples as disclosed herein. In some examples, aspects of the operations of 1330 may be performed by a user identification component 950 as described with reference to FIG. 9.

At 1335, the method may include assigning the request to a user of the subset of users based at least in part on a load balancing logic and the plurality of utilization scores. The operations of 1335 may be performed in accordance with examples as disclosed herein. In some examples, aspects of the operations of 1335 may be performed by a calculation metric component 955 as described with reference to FIG. 9.

A method for data processing is described. The method may include retrieving time resource utilization information for a plurality of users from a plurality of time resource management application instances associated with the plurality of users, wherein the time resource utilization information indicates unavailable time resources for users of the plurality of users for a configured time period, computing a plurality of utilization scores for the plurality of users based at least in part on the retrieving, wherein a utilization score comprises an aggregation of unavailable time resources corresponding to the configured time period for a user of the plurality of users, receiving a request to utilize an available time resource for a specified time slot, querying a data object storing the plurality of utilization scores to identify a subset of users of the plurality of users having a lowest utilization score, retrieving, from a subset of time resource management application instances associated with the subset of users and in response to the querying, time slot availability information corresponding to the configured time period for the subset of users, and identifying one or more users from the subset of users having the available time resource for the specified time slot.

An apparatus for data processing is described. The apparatus may include a processor, memory coupled with the processor, and instructions stored in the memory. The instructions may be executable by the processor to cause the apparatus to retrieve time resource utilization information for a plurality of users from a plurality of time resource management application instances associated with the plurality of users, wherein the time resource utilization information indicates unavailable time resources for users of the plurality of users for a configured time period, compute a plurality of utilization scores for the plurality of users based at least in part on the retrieving, wherein a utilization score comprises an aggregation of unavailable time resources corresponding to the configured time period for a user of the plurality of users, receive a request to utilize an available time resource for a specified time slot, query a data object storing the plurality of utilization scores to identify a subset of users of the plurality of users having a lowest utilization score, retrieve, from a subset of time resource management application instances associated with the subset of users and in response to the querying, time slot availability information corresponding to the configured time period for the subset of users, and identify one or more users from the subset of users having the available time resource for the specified time slot.

Another apparatus for data processing is described. The apparatus may include means for retrieving time resource utilization information for a plurality of users from a plurality of time resource management application instances associated with the plurality of users, wherein the time resource utilization information indicates unavailable time resources for users of the plurality of users for a configured time period, means for computing a plurality of utilization scores for the plurality of users based at least in part on the retrieving, wherein a utilization score comprises an aggregation of unavailable time resources corresponding to the configured time period for a user of the plurality of users, means for receiving a request to utilize an available time resource for a specified time slot, means for querying a data object storing the plurality of utilization scores to identify a subset of users of the plurality of users having a lowest utilization score, means for retrieving, from a subset of time resource management application instances associated with the subset of users and in response to the querying, time slot availability information corresponding to the configured time period for the subset of users, and means for identifying one or more users from the subset of users having the available time resource for the specified time slot.

A non-transitory computer-readable medium storing code for data processing is described. The code may include instructions executable by a processor to retrieve time resource utilization information for a plurality of users from a plurality of time resource management application instances associated with the plurality of users, wherein the time resource utilization information indicates unavailable time resources for users of the plurality of users for a configured time period, compute a plurality of utilization scores for the plurality of users based at least in part on the retrieving, wherein a utilization score comprises an aggregation of unavailable time resources corresponding to the configured time period for a user of the plurality of users, receive a request to utilize an available time resource for a specified time slot, query a data object storing the plurality of utilization scores to identify a subset of users of the plurality of users having a lowest utilization score, retrieve, from a subset of time resource management application instances associated with the subset of users and in response to the querying, time slot availability information corresponding to the configured time period for the subset of users, and identify one or more users from the subset of users having the available time resource for the specified time slot.

Some examples of the method, apparatuses, and non-transitory computer-readable medium described herein may further include operations, features, means, or instructions for receiving a user input indicating a user configuration defining a calculation metric for computing the plurality of utilization scores.

In some examples of the method, apparatuses, and non-transitory computer-readable medium described herein, the calculation metric comprises a total number of unavailable hours during to the configured time period or a total number of meetings scheduled during the configured time period.

In some examples of the method, apparatuses, and non-transitory computer-readable medium described herein, computing the plurality of utilization scores may include operations, features, means, or instructions for identifying the aggregation of unavailable time resources corresponding to the configured time period for the user of the plurality of users based at least in part on the calculation metric.

Some examples of the method, apparatuses, and non-transitory computer-readable medium described herein may further include operations, features, means, or instructions for assigning the request to a user of the subset of users based at least in part on a load balancing logic and the plurality of utilization scores.

Some examples of the method, apparatuses, and non-transitory computer-readable medium described herein may further include operations, features, means, or instructions for updating the plurality of utilization scores for the one or more users from the subset of users identified as having the available time resource for the specified time slot based at least in part on the assigning.

In some examples of the method, apparatuses, and non-transitory computer-readable medium described herein, querying the data object may include operations, features, means, or instructions for querying the data object storing the plurality of utilization scores to identify a subset of users of the plurality of users having a subset of lowest utilization scores relative to the plurality of users.

In some examples of the method, apparatuses, and non-transitory computer-readable medium described herein, a time resource management application instance comprises a calendar application, an appointment scheduler application, a personal information management application, or any combination thereof.

In some examples of the method, apparatuses, and non-transitory computer-readable medium described herein, a utilization score indicates a total number of unavailable hours during to the configured time period or a total number of meetings scheduled during the configured time period.

In some examples of the method, apparatuses, and non-transitory computer-readable medium described herein, receiving the request may include operations, features, means, or instructions for receiving the request to utilize the available time resource for the specified time slot, wherein the request comprises an indication of a work type, a service territory, or both corresponding to the available time resource.

Some examples of the method, apparatuses, and non-transitory computer-readable medium described herein may further include operations, features, means, or instructions for querying the data object storing the plurality of utilization scores to identify a subset of users of the plurality of users having a lowest utilization score and corresponding to the work type, the service territory, or both based at least in part on the receiving.

Some examples of the method, apparatuses, and non-transitory computer-readable medium described herein may further include operations, features, means, or instructions for generating a table storing the time resource utilization information for a user from a time resource management application instance associated with the user, wherein the time resource utilization information indicates unavailable time resources for the user for a configured time period, one or more related records, a parent record, a work type, a service territory, or any combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
retrieving time resource utilization information for a plurality of users from a plurality of time resource management application instances associated with the plurality of users, wherein the time resource utilization information indicates unavailable time resources for users of the plurality of users for a configured time period;
computing a plurality of utilization scores for the plurality of users based at least in part on the retrieving, wherein a utilization score comprises an aggregation of unavailable time resources corresponding to the configured time period for a user of the plurality of users;
receiving a request to utilize an available time resource for a specified time slot;
querying a data object storing the plurality of utilization scores to identify a subset of users of the plurality of users having a lowest utilization score;
retrieving, from a subset of time resource management application instances associated with the subset of users and in response to the querying, time slot availability information corresponding to the configured time period for the subset of users; and
identifying one or more users from the subset of users having the available time resource for the specified time slot.

2. The method of claim 1, further comprising:
receiving a user input indicating a user configuration defining a calculation metric for computing the plurality of utilization scores.

3. The method of claim 2, wherein the calculation metric comprises a total number of unavailable hours during to the configured time period or a total number of meetings scheduled during the configured time period.

4. The method of claim 2, wherein computing the plurality of utilization scores comprises:
identifying the aggregation of unavailable time resources corresponding to the configured time period for the user of the plurality of users based at least in part on the calculation metric.

5. The method of claim 4, further comprising:
assigning the request to a user of the subset of users based at least in part on a load balancing logic and the plurality of utilization scores.

6. The method of claim 5, further comprising:
updating the plurality of utilization scores for the one or more users from the subset of users identified as having the available time resource for the specified time slot based at least in part on the assigning.

7. The method of claim 1, wherein querying the data object comprises:
querying the data object storing the plurality of utilization scores to identify a subset of users of the plurality of users having a subset of lowest utilization scores relative to the plurality of users.

8. The method of claim 1, wherein a time resource management application instance comprises a calendar application, an appointment scheduler application, a personal information management application, or any combination thereof.

9. The method of claim 1, wherein a utilization score indicates a total number of unavailable hours during to the configured time period or a total number of meetings scheduled during the configured time period.

10. The method of claim 1, wherein receiving the request comprises:
receiving the request to utilize the available time resource for the specified time slot, wherein the request comprises an indication of a work type, a service territory, or both corresponding to the available time resource.

11. The method of claim 10, further comprising:
querying the data object storing the plurality of utilization scores to identify a subset of users of the plurality of users having a lowest utilization score and corresponding to the work type, the service territory, or both based at least in part on the receiving.

12. The method of claim 1, further comprising:
generating a table storing the time resource utilization information for a user from a time resource management application instance associated with the user, wherein the time resource utilization information indicates unavailable time resources for the user for a configured time period, one or more related records, a parent record, a work type, a service territory, or any combination thereof.

13. An apparatus for data processing, comprising:
a processor;
memory coupled with the processor; and
instructions stored in the memory and executable by the processor to cause the apparatus to:
retrieve time resource utilization information for a plurality of users from a plurality of time resource management application instances associated with the plurality of users, wherein the time resource utilization information indicates unavailable time resources for users of the plurality of users for a configured time period;
compute a plurality of utilization scores for the plurality of users based at least in part on the retrieving, wherein a utilization score comprises an aggregation of unavailable time resources corresponding to the configured time period for a user of the plurality of users;
receive a request to utilize an available time resource for a specified time slot;
query a data object storing the plurality of utilization scores to identify a subset of users of the plurality of users having a lowest utilization score;
retrieve, from a subset of time resource management application instances associated with the subset of users and in response to the querying, time slot availability information corresponding to the configured time period for the subset of users; and
identify one or more users from the subset of users having the available time resource for the specified time slot.

14. The apparatus of claim 13, wherein the instructions are further executable by the processor to cause the apparatus to:
receive a user input indicating a user configuration defining a calculation metric for computing the plurality of utilization scores.

15. The apparatus of claim 14, wherein the calculation metric comprises a total number of unavailable hours during to the configured time period or a total number of meetings scheduled during the configured time period.

16. The apparatus of claim 14, wherein the instructions to compute the plurality of utilization scores are executable by the processor to cause the apparatus to:
identify the aggregation of unavailable time resources corresponding to the configured time period for the user of the plurality of users based at least in part on the calculation metric.

17. The apparatus of claim 16, wherein the instructions are further executable by the processor to cause the apparatus to:
assign the request to a user of the subset of users based at least in part on a load balancing logic and the plurality of utilization scores.

18. The apparatus of claim 17, wherein the instructions are further executable by the processor to cause the apparatus to:
update the plurality of utilization scores for the one or more users from the subset of users identified as having the available time resource for the specified time slot based at least in part on the assigning.

19. The apparatus of claim 13, wherein the instructions to query the data object are executable by the processor to cause the apparatus to:
query the data object storing the plurality of utilization scores to identify a subset of users of the plurality of users having a subset of lowest utilization scores relative to the plurality of users.

20. A non-transitory computer-readable medium storing code for data processing, the code comprising instructions executable by a processor to:
retrieve time resource utilization information for a plurality of users from a plurality of time resource management application instances associated with the plurality of users, wherein the time resource utilization information indicates unavailable time resources for users of the plurality of users for a configured time period;
compute a plurality of utilization scores for the plurality of users based at least in part on the retrieving, wherein a utilization score comprises an aggregation of unavailable time resources corresponding to the configured time period for a user of the plurality of users;
receive a request to utilize an available time resource for a specified time slot;
query a data object storing the plurality of utilization scores to identify a subset of users of the plurality of users having a lowest utilization score;
retrieve, from a subset of time resource management application instances associated with the subset of users and in response to the querying, time slot availability information corresponding to the configured time period for the subset of users; and
identify one or more users from the subset of users having the available time resource for the specified time slot.
